(19) United States
(12) Patent Application Publication
(10) Pub. No.: US 2006/0108376 A1
(43) Pub. Date: May 25, 2006

(54) Dispenser device

(76) Inventor: Simon Andrew Huber Muir, Point Cook (AU)

Correspondence Address: KIRK HAHN, 14431 HOLT AVE, SANTA ANA, CA, 92705, US

(21) Appl. No.: 10/541,971

(22) PCT Filed: Jan. 13, 2004
(86) PCT No.: PCT/AU04/00039

§ 371 Date: Jul. 12, 2005

(30) Foreign Application Priority Data
Jan. 13, 2003 (AU) 2003900130
Aug. 1, 2003 (AU) 2003904005

(51) Int. Cl. B67D 5/64

(52) U.S. Cl. 222/129

(57) ABSTRACT

Cylindrical dispenser (51) is attached in-line to a hose so as to add dispersible solids (89) in the form of granules or cartridges, eg of fertiliser, to liquid, eg water, flowing (75) though the hose. A proportion of the flow passing through conduit (85) (which has holes, slots, or is fibrous) enters surrounding compartment (87) and leaves it again to form part of flow (75) carrying with it dissolved, suspended, etc, fertiliser absorbed during its passage through compartment (87).

### TECHNICAL FIELD

This invention relates to a dispenser adapted for use in adding soluble or dispersible fertilizers and/or other materials to flowing water that is to be distributed through a hose or other water conduit onto gardens, lawns, cultivated areas and the like.

### BACKGROUND ART

Fertilization of gardens and lawns, particularly domestic gardens and lawns, is increasingly common. This may be done in a variety of ways. For example, a home owner may spread fertilizer by hand on lawns/garden beds prior to watering the lawns/gardens to wash in the fertilizer to the plant roots. Whilst this approach is reasonably effective, it requires two steps, namely a step of spreading the fertilizer and a watering step. Furthermore, it is difficult to meter out fertilizer evenly by hand. As the fertilizer is generally thrown over an area in concentrated crystalline form, it may fall unevenly leading to unevenness of fertilization and uneven resultant growth enhancement. It may also end up directly in contact with the roots or leaves of plants and cause localised “burning” of the plant where contact occurs. In addition to these difficulties, the step of spreading by hand may easily lead to skin contact with the fertilizer if adequate protective measures are not taken by the person carrying out that step, and this may be uncomfortable or unhealthy.

Another way in which fertilization of gardens, lawns and the like may be achieved is to mix the fertilizer (obtained in liquid or gel form, or as a powder or granules) with water in a set proportion and thereafter spray the solution (or mixture) onto the area required. The spraying step may involve a suitable spraying device or, alternatively, equipment for mixing the fertilizer solution with water flowing in a hose or other distribution conduit. Again, this is a two-stage process, and the step of mixing the fertilizer with water may lead to spillage, incorrect proportions of fertilizer and water, or undesirable skin contact.

Apparatus and methods whereby fertilizer (in solid, liquid, gel or other form) is mixed directly with water flowing in the hose or other distribution conduit have been introduced and can alleviate the above problems. However, some of these are comparatively complex, and therefore costly, others are believed to be prone to uneven mixing, and still others are reliant on the use of special cartridges.

Thus there is a need for a simple approach to applying fertilizer to lawns/plants which is not excessively labour intensive and which can be used to facilitate a relatively even application of fertilizer to the ground being watered. Desirably, low pressure loss is desired. Also, the ability to assume a range of orientations and to be mountable in-line between lengths of hose (or between a tap and a hose) is desirable for convenience in use.

As an example of fertilizer dispensing devices that are not based on the use of a cartridge, U.S. Pat. No. 5,772,115 (Vaughan) discloses a fertilizer dispensing device in which granular fertilizer is placed in a perforated basket in a mixing chamber through which a proportion of water flowing between an inlet and an outlet of the device is diverted. This device appears unsuited to in-line mounting between lengths of hose. When water flow is stopped before exhaustion of the fertilizer in the mixing chamber, it is believed that a high concentration of fertilizer can occur in water left in the mixing chamber and that when flow is restarted, there can accordingly be a period of excessive solution strength in water emerging from the device. U.S. Pat. No. 5,199,645 is another, more complex, example of devices of this type.

U.S. Pat. No. 4,477,960 (Knapp) discloses a dispensing device for connection between a water supply and a conduit through which the water is delivered to a garden, lawn or the like and in which fertilizer is mixed with the water as it flows through the device. The fertilizer is supplied as a cylindrical cartridge formed from a gel with the fertilizer suspended therein, the cartridge being placed in a compartment within the device. Water flows through a bore in the cartridge and progressively dissolves it, releasing the fertilizer into the water. This device is simple and the only preparation required for its use is to place the cartridge in the compartment and make inlet and outlet connections. However, a specialized cartridge is required. Moreover, it appears that as the cartridge dissolves, there is an undesirable tendency for the bore to collapse into the waterflow. It is believed that this may cause significant and unpredictable variability in the fertilizer dosage rate, or even clogging of the device. Therefore, the cartridge is preferably provided with a tube of plastic or wire netting to support the bore. While this netting no doubt stabilizes the cartridge bore to some degree, it clearly cannot do so for the whole life of the cartridge, and must be retrieved, removed and disposed of when the cartridge is spent, a messy and unpleasant task.

U.S. Pat. No. 4,333,493 (Beiswenger) discloses another dispensing device which relies on the use of a special cup-shaped cartridge for the fertilizer. The cartridge is opened, inverted and placed in a mixing chamber, and a proportion of the water flowing between inlet and outlet ports of the device is diverted into the mixing chamber where fertilizer is mixed or dissolved with it, the diverted water then re-entering the main water flow. This device relies on a cartridge that is specifically made for use in it, although the cartridge is simpler and probably cheaper than that of Knapp. The cartridge must be removed from the mixing chamber and then disposed of, when spent. One stated motivation for the Beiswenger device is to provide for a fertilizer metering orifice to be in the cartridge rather than the device itself, to avoid inaccurate metering due to clogging.

U.S. Pat. No. 4,385,034 (Gacer) discloses a device somewhat similar to that of Beiswenger, but that does not rely on a special cartridge. In fact it can inject both liquid and solid substances into a water flow. Like the Beiswenger device, this appears to be unsuited to in-line mounting between lengths of hose. It may also be prone to clogging.

Both the Beiswenger and Knapp devices are stated to have the advantage of low pressure losses.

### DISCLOSURE OF INVENTION

The invention provides in a first aspect an in-line dispenser for adding a dispersible solid to a flow of liquid said dispenser comprising:
a liquid conduit having a tubular wall extending between an inlet and an outlet, and
a container for the dispersible solid having at least one wall comprising at least a part of the tubular wall,
wherein the at least a part of the tubular wall is permeable to liquid but is substantially impermeable to the dispersible solid, whereby liquid flowing through the liquid conduit from the inlet to the outlet may flow from within the liquid conduit into the container to come into contact with the dispersible solid to dissolve or otherwise disperse the dispersible solid in the liquid in a form which allows the liquid containing the dispersed solid to re-enter the liquid conduit.

The dispersible solid may comprise any solid which can either dissolve in the liquid or be in any other way dispersed or suspended in the liquid in a form which allows it to pass through the permeable wall. It may comprise a particulate material such as fertilizer crystals. The size of the particulate material will be such as to substantially prevent it passing through the permeable tubular wall. It may typically comprise a common fertilizer such as potassium, phosphates or nitrates. Alternatively or additionally, it may comprise a material for treating lawns/plants such as an insecticide, or a herbicide. It may comprise mixtures of the foregoing.

Typically, the liquid will comprise water. The water may be used to water lawns/plants in a typical home garden. However, this is not intended to preclude use of the invention in connection with watering or irrigating in commercial gardening, agricultural or horticultural applications

Preferably, the tubular wall is rendered permeable by virtue of including one or more holes or slots therethrough. Preferably also, said holes or slots are of sufficiently narrow diameter or width to prevent the particulate material passing therethrough. For many applications, the said diameter or width may be in the range 0.2 to 3 mm.

However, where necessary to deal with different characteristics of the solid material to be used and/or with exceptionally small or large flow rates, other sizes may be used. In particular, the said diameter or width may be in the range 0.02 to 0.2 mm or in the range 3 to 10 mm.

The holes take the form of circular openings. They may also have the form of elongate slots.

Alternatively, the tubular wall of the liquid conduit may be formed of a material which is inherently permeable to water or other liquid. The tubular wall may include a fibrous material. The fibrous material may include fibres that are woven.

Preferably, the liquid conduit is mounted to extend between inlet and outlet ports of a main body, so that a space between the main body and the liquid conduit defines the container for holding the dispersible solid.

It is particularly preferred that said main body includes a cylindrical outer barrel and that said conduit is mounted co-axially with said outer barrel.

An end of the co-axially mounted outer barrel and liquid conduit may be joined in such a manner as to close off the container at that end.

Preferably, the dispenser includes attachment means for releasably connecting the dispenser to a water supply means and a distribution means so that water can flow from the water supply means to the distribution means through the liquid conduit.

At least one said attachment means may include a screw thread matingly connectable to said water supply means or distribution means. Alternatively, however, a said attachment means may be adapted to be snap-fittingly securable to said water supply means or distribution means.

The dispenser preferably further includes filter means adapted to filter out particulates in fluid travelling through the liquid conduit. Preferably also, the filter means is positioned downstream of the container, so that particulates arising from the solid material in use can be captured.

The dispenser preferably also includes a check valve located to be upstream of the liquid conduit in use.

In a further aspect, the invention provides a method for adding to a stream of water used for watering an area of earth a substance that is available in granular or powder form, comprising the steps of:
providing a dispenser according to any of the forms set out above;
placing a quantity of the substance in the container of the dispenser;
connecting the dispenser to a water supply means and a water distribution means; and
causing a flow of water from the water supply means to the water distribution means through the dispenser.

In a still further aspect, the invention provides a method for adding to a s stream of water used for watering an area of earth a substance that is able to be formed into or held in a solid body dissoluble by water, comprising the steps of:
providing a dispenser according to any one of the forms set out above;
placing at least one solid body of or containing the substance in the container of the dispenser;
connecting the dispenser to a water supply means and a water distribution means; and
causing a flow of water from the water supply means to the water distribution means through the dispenser,
so that the body is dissolved by the action of water flowing into the container and the substance enters the water.

Preferably, the solid body has a bore which when when the solid body is placed into the compartment surrounds the liquid conduit of the dispenser.

The dispenser according to the invention may typically be manufactured of a relatively inert and rust-proof material such as a thermoplastic. It may be injection moulded in several components. The container may be permanently sealed. It may be disposable once the dispersible solid has been completely entrained in the water flowing through the liquid conduit. Window means may be provided in the outer barrel to view the level or quantity of dispersible solid in the container.

As the in-line dispenser may be used in a system for watering a garden or lawn, the invention also has within its scope any such system incorporating in-line dispensers as hereinbefore described. Such systems may include an array of sprinklers, drip nozzles or the like. They may also include a subsurface hose for feeding water to the sprinklers.

sible solid entrained therein.

Preferred aspects of the invention will now be non-limitingly described with reference to the accompanying drawings.

### BRIEF DESCRIPTION OF DRAWINGS

FIG. 1 shows an exploded view of a dispenser with a cut out portion according to the invention;

FIG. 2 shows the dispenser of FIG. 1 in assembled form;

FIG. 3 shows a cross-section of the dispenser of FIG. 2 taken along its elongate axis;

FIG. 4 shows a sprinkler array incorporating the dispenser of the invention.;

FIG. 5 shows an exploded view of an alternative dispenser construction with a cut out portion according to the invention;

FIG. 6 shows the dispenser of FIG. 5 in assembled form; and

FIG. 7 shows a cross section of the dispenser of FIG. 5 taken along its elongate axis.

### PREFERRED MODES FOR CARRYING OUT THE INVENTION

The following description is not intended to limit practice of the invention to precisely the embodiments described. Many possible variations will occur to a person skilled in the art and can be followed if appropriate.

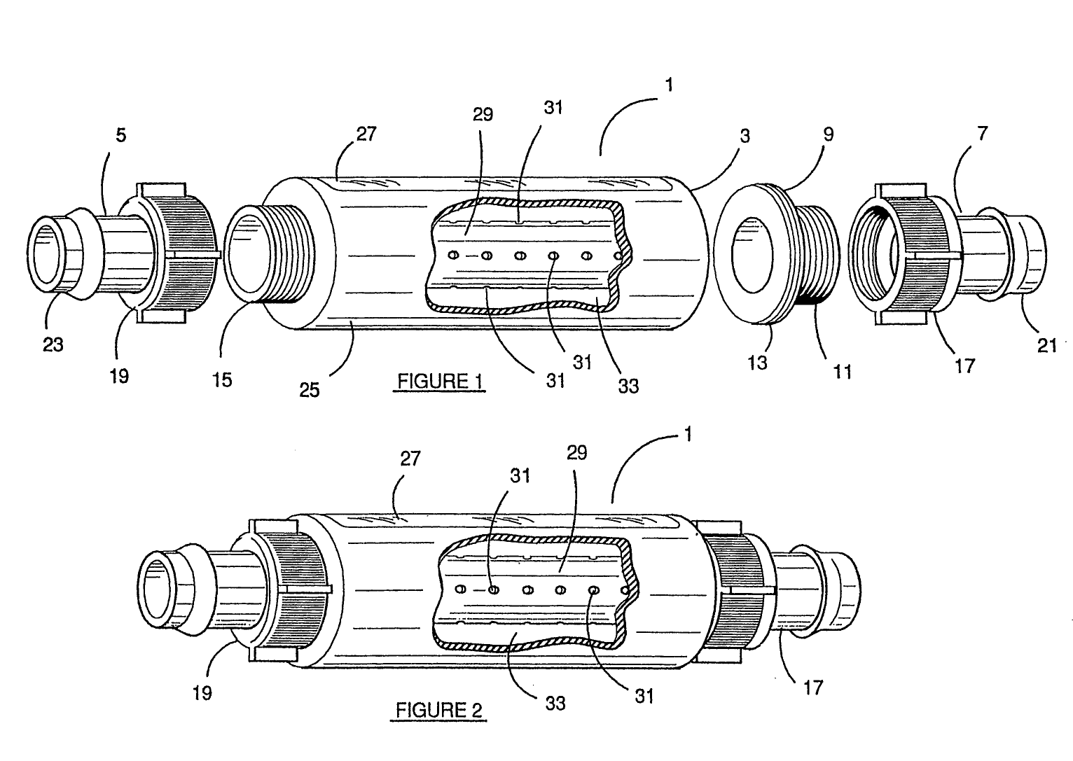

Referring to FIGS. 1 to 3 of the accompanying drawings there is shown a dispenser generally designated 1 that is an assembly of a number of components shown most clearly in FIG. 1, an exploded view.

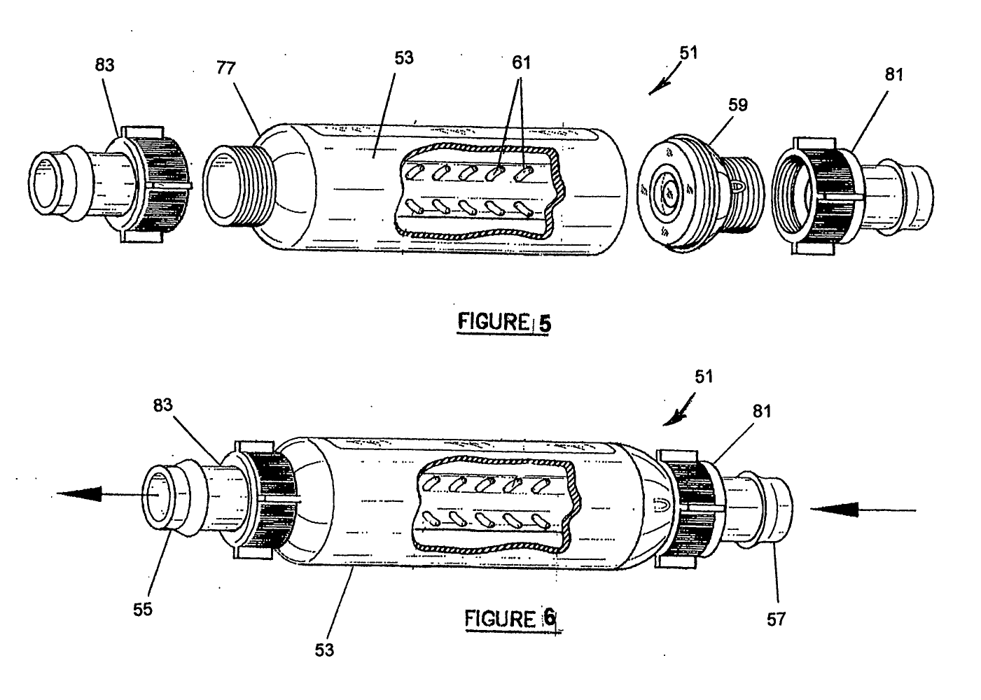

The dispenser 1 comprises a main body 3 provided with inlet and outlet end hose connectors 7 and 5 respectively. Hose connector 7 comprises a spigot 21 for insertion into hose 43 (see FIG. 4) and an internally threaded screw coupler 17. Spigot 21 has an integral annular barb 4 to enhance grip in hose 43. An external clip (not shown) may be provided externally on hose 43 to grip hose 43 and therefore increase resistance to hose 43 separating from connector 7. Similarly, outlet end hose connector 5 comprises a spigot 23 and internally threaded screw coupler 19, spigot 23 having an annular barb 6.

Connectors 5 and 7 are of well-known type. However, they are not of the essence of the invention and other types of hose connector available on the market may be provided if required. In particular, “snap-fit” connectors are well known and are commonly used on garden hoses. Such connectors (not shown) have the advantage of enabling rapid and easy connection and disconnection to hoses and taps (also known as faucets) with mating fittings, and their use is preferred.

Main body 3 includes a cylindrical outer barrel 25 that is internally screw threaded at one end to receive a screw member 9. Screw member 9 includes a screw threaded section 13 which can be screwed into the corresponding internal screw thread provided in the outer barrel 25 of the main body. A screw thread 11 of smaller diameter extends from section 13 of screw member 9 to connect with the screw thread of the screw coupler 17 forming part of the hose connector 7.

A screw-threaded extension 15 formed integrally and coaxially with main body 3 corresponds in function to the screw threaded section 11 of member 9 and enables hose connector 5 to be secured by associated screw coupler 19 to main body 3.

Outer barrel 25 includes a window 27 to enable viewing of particulate fertilizer 35 held therein. Alternatively, outer barrel 25 may be formed of a suitable transparent plastics material, so that window 27 is not required for viewing of the fertilizer material 35.

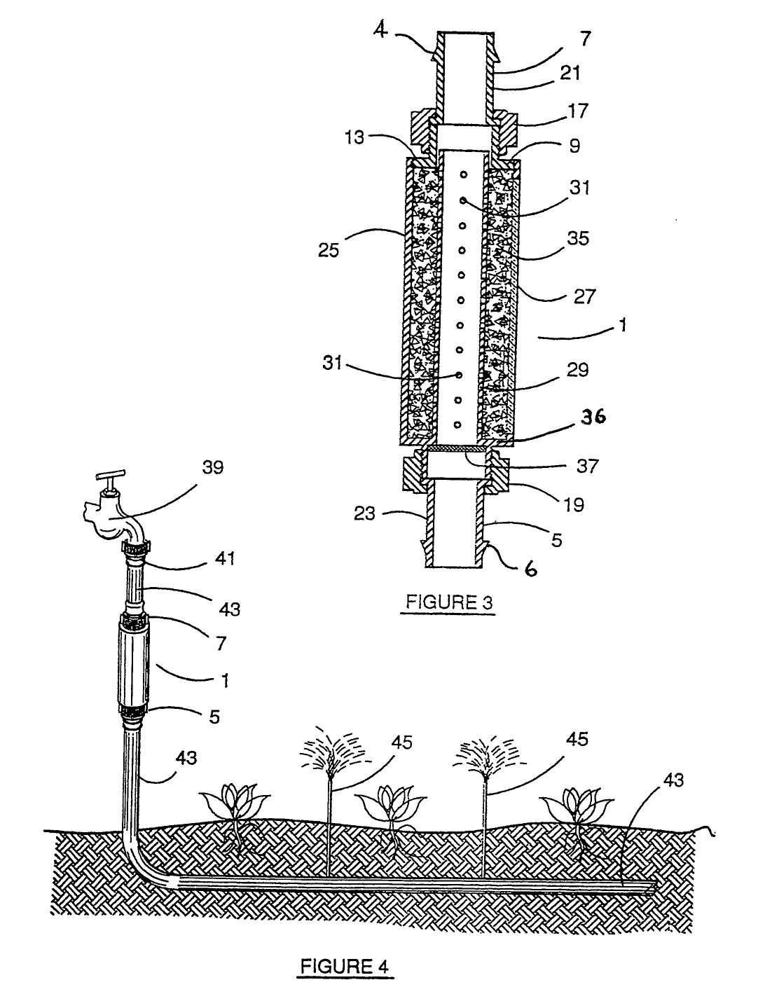

In addition to outer barrel 25, the main body 3 of dispenser 1 includes a tubular inner conduit 29, coaxial with outer barrel 25. Inner conduit 29 and outer barrel 25 define an annular container 33 for the fertilizer 35. As best seen in FIG. 3, ends of annular container 33 are defined by a wall 36 and, when dispenser 1 is assembled, by member 9.

A number of round holes 31 which are small enough to prevent the bulk of the particulate fertilizer solid 35 from passing therethrough in undissolved form are provided in conduit 29 to allow communication between water flowing through the inner conduit 29 and the annular container 33. This allows the water to progressively dissolve or otherwise entrain the particulate fertilizer 35 so that it joins the flow of water travelling through the inner conduit 29.

Although reference has been made to a particulate fertilizer 35, it is to be understood that particulate materials in addition to or other than fertilizer may also be provided in the annular container 33 of dispenser 1 for entraining in water flowing therethrough. They may be entrained by solution or by suspension. They may include microcapsules which can contain fertilizer or treatment chemicals.

Whilst the illustrated embodiment shows holes 31 in conduit 29, it is to be appreciated that any method of rendering the inner conduit permeable to water should also be suitable provided the method substantially prevents the undissolved or undispersed particulate fertilizer 35 or other material from passing through the inner conduit 29 whilst allowing the dissolved or suspended material to flow into the inner conduit.

A disc of filter mesh 37 is provided near the outlet of the inner conduit 29 to catch any small pieces of grit or particulate fertilizer 35 which may be entrained in the water flow through the inner conduit 29,

It can be seen from FIG. 4 that a dispenser 1 according to the invention may be added in line to a typical garden watering system where a tap (faucet) 39 is connected via a conventional hose connector 41 to a hose 43. The hose 43 directs liquid through the dispenser 1 and hence to a series of sprinklers 45.

To prepare dispenser 1 for use, a quantity of fertilizer 35 is first placed into annular container 33. Annular container 33 is then closed by screwing member 9 and hose connector 7 into their respective assembled positions. Then, all that is necessary to apply the fertilizer 35 to an area is to pass water through the hose 43 and dispenser 1, so that fertilizer 35 is entrained, dissolved or mixed in the water as it passes through dispenser 1. Loss of water pressure in dispenser 1 is small by comparison to some of the other dispensers described earlier. When annular container 33 has been emptied of fertilizer 35, this is apparent to the user by observation through window 27 (or transparent outer barrel 25) and the process of filling and applying can be repeated. No cartridge or cartridge part need be retrieved and disposed of.

It can be seen that the invention allows fertilizer or other material to be continuously dissolved or dispersed in liquid as it travels through the hose and inner conduit and therefore reduces the likelihood of excessive concentration of fertilizer or other materials by comparison with hand distribution methods whilst at the same time providing a convenient method of distribution which does not require an application step in addition to the step of watering.

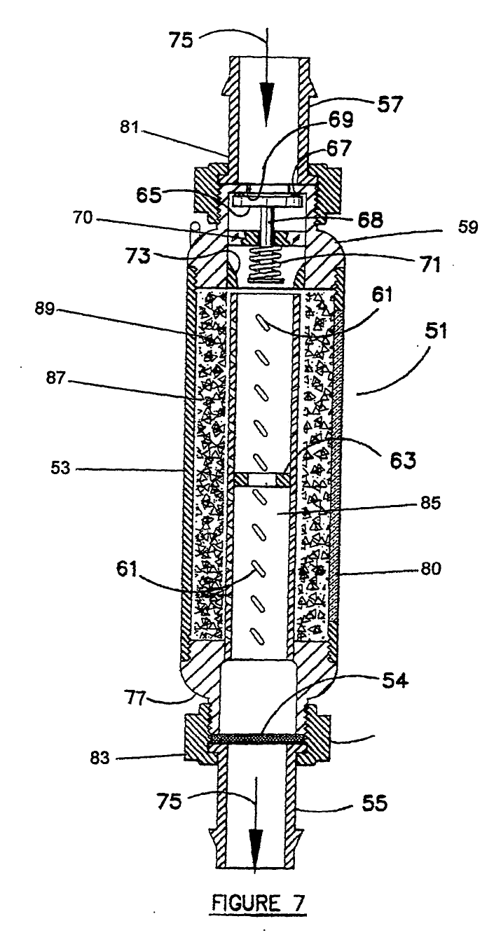

Referring now to FIGS. 5 to 7 of the accompanying drawings, it can be seen that the dispenser construction generally designated 51 in broad respects resembles that described with reference to FIGS. 1 to 3. Snap-fit connectors (not shown) of known type may be used as an alternative to either or both of the conventional connectors 81 and 83 shown, which are of the same type as connectors 5 and 7 described above. Such snap-fit connectors are well known and not of the essence of the invention, and therefore no description of such connectors is required or provided here. Save that the use of snap-fit connectors is preferred, dispenser 51 is the preferred embodiment of the invention.

Spigots 55 and 57 are included in outlet and inlet end hose connectors 83 and 81 to allow dispenser 51 to be connected in line to a hose (not shown) in the same manner as shown with dispenser 1 in FIG. 4. However, dispenser 51 may with suitable fittings be connected directly to a tap at its inlet end.

Dispenser 51 includes a main body 53 having a cylindrical outer barrel 80 and a tubular inner conduit 85 coaxial with outer barrel 80. Both outer barrel 80 and inner conduit 85 are threadably secured to an end piece 77. Corresponding in function to screw member 9 of dispenser 1 is an inlet end piece 59, that mates threadably with outer barrel 80. Outer barrel 80 is shown (FIG. 5) as having a transparent window 53 to allow viewing of the contents of the dispenser 51, but may alternatively be made of a transparent plastics material so that window 53 is not required.

The use of screw threaded inlet and outlet end pieces 59 and 77 joining the screw threaded ends of the outer barrel 80 allows easy assembly and disassembly.

Inner conduit 85 serves the same purpose as inner conduit 29 of dispenser 1. Between and defined by inner conduit 85 and outer barrel 80 is an annular compartment 87 for holding fertilizer 89.

Inner conduit 85 is provided with slots 61 (rather than the round holes 31 of inner conduit 29 of dispenser 1) to assist with improving the flow of water out of inner conduit 29 into compartment 87 through the fertilizer 89 therein and back again into inner conduit 29. However, it is to be understood that the precise number size shape and orientation of openings such as slots 61 is able to be varied to work best with the fertilizer or other materials most likely to be used in dispenser 51. Such variations can be determined by ordinary trial and error without the necessity for any inventiveness.

An annular restriction 63 is also provided centrally along inner conduit 85 to increase turbulence and hence facilitate dispersion of the particulate fertilizer in the water, and/or to provide a difference in pressure between sections of conduit 85 upstream and downstream of restriction 63, further enhancing movement of water into and out of the compartment 87.

Inner conduit 85 is shown as being distinct from outlet end piece 77, and may be assembled thereto by gluing, screwing, or by being an interference fit therein. Dispenser 51 is more easily manufactured with conduit 85 being a separate component from end piece 77, and this is essential where conduit 85 and end piece 77 are to be of different materials. This may arise if conduit 85 is to be manufactured of a fibrous or otherwise inherently material rather than as a perforated tube, such an arrangement being within the scope of the invention. However, it is also possible for conduit 85 and end piece 77 to be formed integrally as a single component.

A disc-shaped filter mesh 54 is held between end piece 77 and screw coupler 79 of outlet end hose connector 83. This arrangement allows easy removal of the filter mesh 54 for cleaning as required. It will be apparent to persons skilled in the art that filter mesh 54 could if preferred be secured within end piece 77 by means distinct from hose connector 83 so that disconnecting connector 83 would not automatically release filter mesh 54.

Incorporated in inlet end piece 59 is a one-way valve, having a movable valve member 65, to prevent backwash of water laden with fertilizer into the tap and associated water delivery systems in the event, for example, of a loss of water pressure.

Whilst various types of one way valves can be used, the very simple form of valve member 65 shown in the drawings is suitable for most applications.

Valve member 65 is secured to a valve stem 68 and is provided with an annular gasket 67 for sealing against a face 69 of end piece 59.

A valve guide 70 is provided in end piece 59 to both hold and slidably guide the valve stem in association with a tension spring 71 which urges the valve member 65 into sealing abutment with face 69.

It can be seen that water flow in the direction of the arrow 75 from a tap or other water source urges valve member 65 away from face 69 to allow flow through of water into conduit 85. Backflow or pressure of water in the reverse direction automatically results in the spring 71 acting in the same direction as the spring tension to close the valve member 65 against face 69.

An annular venturi shoulder 73 may also be provided in inlet end piece 59 to assist with regulating pressure of water traveling through the dispenser 51. Shoulder 73 may be a separate component from end piece 59, as shown, or integrally formed therewith.

In use of dispenser 51, access to compartment 87 is provided by unscrewing end piece 59 from outer barrel 80 and inserting sufficient fertilizer (or other material) 89 therein. End piece 59 is then screwed back into barrel 80 and water passed through the now-assembled dispenser 51 to mix the material 89 progressively with water flowing through dispenser 51. The process can be repeated when all material 89 is spent.

It will be noted that although dispenser 51 lends itself readily to use with fertilizer or other material supplied in granular, powder, capsule or like form, nothing prevents the supply and use with it of a specialized cartridge (not shown). Such a cartridge could be in the form of a cylindrical element with a central bore, for example made of a gel such as that of Knapp described in U.S. Pat. No. 4,477,960. The central bore would allow the tubular conduit 85 to pass through it. Alternatively, one or more cartridges in the form of a solid washer (not shown) with a central hole therethrough could be used, the or each washer being placed over the conduit 85 in the manner of a washer being placed on a bolt. Such cartridges would be much simpler (hence less costly) than those described by Knapp or Beiswenger (U.S. Pat. No. 4,333,493) and as easily handled. They could even be formulated to dissolve at differing rates to allow better control of fertilizer distribution. No retrieval after use of such cartridges would be necessary, as they would simply dissolve away, and the difficulty of supporting the bore of the Knapp cartrtridge would not be present.

It was not immediately apparent that simple dispensers (1, 51) according to the invention would perform satisfactorily, but surprisingly this has been found to be so. A prototype dispenser according to the invention demonstrated pressure drops of 30 kPa (at inlet pressure 630 kPa and flow 9.1 l/min) and 100 kPa (at inlet pressure 550 kPa and flow 16 l/min), which figures were found satisfactory for use with ordinary domestic sprinklers located downstream. The prototype was able to dissolve and distribute most of a 200 g charge of fertilizer in about 20 minutes at flow rates in the above order. No clogging of nozzles of sprinklers downstream of the prototype device was experienced.

The dispensers described above lend themselves well to production in injection moulded plastics, but it will be recognized that other production methods may also be used if required. For example only, some or all components (other than those required to be transparent) could be produced in cast and/or machined metals, such as brass.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It is to be understood that where the word “comprise”, and variations such as “comprises” and “comprising”, are used in this specification, unless the context requires otherwise such use is intended to imply the inclusion of a stated feature or features but is not to be taken as excluding the presence of other feature or features.

1. An in-line dispenser for adding a dispersible solid to a flow of liquid comprising:
a liquid conduit having a tubular wall and extending between an inlet and an outlet, and
a container for the dispersible solid having at least one wall comprising at least a part of the tubular wall,
wherein the at least a part of the tubular wall is permeable to the liquid but is substantially impermeable to the dispersible solid, so that liquid flowing through the liquid conduit from the inlet to the outlet is able to flow from within the liquid conduit into the container to come into contact with the dispersible solid to dissolve or otherwise disperse the dispersible solid in the liquid in a form which allows the liquid containing the dispersed solid to re-enter the liquid conduit,
and wherein a flow restriction is located within said liquid conduit to increase turbulence in said liquid conduit and/or provide a difference in pressure between liquid in said conduit upstream of said flow restriction and liquid in said conduit downstream of said flow restriction.

2. The in-line dispenser of claim 1, wherein portions of said at least a part of the tubular wall are located upstream and downstream of the flow restriction.

3. The in-line dispenser of claim 1, wherein of the flow restriction comprises an annular formation on an inner face of the tubular wall of said liquid conduit.

4. The in-line dispenser of claim 1, wherein the flow restriction is located centrally along the liquid conduit.

5. The in-line dispenser of claim 1, wherein said at least a part of the tubular wall is rendered permeable by virtue of having one or more holes therethrough.

6. The in-line dispenser of claim 5, wherein the one or more holes are of sufficiently small size to prevent passage therethrough of the dispersible solid.

7. The in-line dispenser of claim 5, wherein said holes are circular

8. The in-line dispenser of claim 5, wherein said holes are slots.

9. The in-line dispenser of claim 1, wherein said at least a part of the tubular wall of the liquid conduit is formed of a material that is inherently permeable to the liquid.

10. The in-line dispenser of claim 9, wherein said material of which said at least a part of the tubular wall is formed comprises fibers that are woven.

11. The in-line dispenser of claim 1, wherein said liquid conduit extends between and is mounted between inlet and outlet ports of a main body, so that a space between the main body and the liquid conduit defines the container for holding the dispersible solid.

12. The in-line dispenser of claim 11, wherein said main body comprises a cylindrical outer barrel and said conduit is mounted within and coaxially with said outer barrel.

13. The in-line dispenser of claim 12, wherein wherein said barrel has a detachable closure at one end that when in position on said barrel closes the container at that end.

14. The in-line dispenser of claim 1, wherein the dispenser comprises attachment means for releasably connecting the dispenser to a water supply means and a distribution means so that water can flow from the water supply means to the distribution means through the liquid conduit.

15. The in-line dispenser of claim 14, wherein a said attachment means comprises a screw thread matingly connectable to said water supply means or distribution means.

16. The in-line dispenser of claim 14, wherein said attachment means is snap-fittingly securable to said water supply means or said distribution means.

17. The in-line dispenser of claims 1, wherein the dispenser comprises filter means adapted to filter out particulates in fluid flowing through the liquid conduit.

18. The in-line dispenser of claim 17, wherein the filter means is positioned downstream of the container.

19. The in-line dispenser of claim 1, wherein the dispenser comprises a check valve positioned upsteam of the liquid conduit.

20. A method of dispensing comprising,
connecting between a water supply means and a water distribution means the in-line dispenser of claim 1,
said in-line dispenser charged with a substance selected from the group consisting of granular, powder formed into a solid body dissoluble by water, and held in a solid body dissoluble by water, and
causing a flow of water from the water supply means to the water distribution means through the dispenser.

21. (canceled)

22. The method of claim 20, wherein the solid body has a bore which when the solid body is placed into the compartment surrounds the liquid conduit of the dispenser.
